(19) United States
(12) Patent Application Publication
(10) Pub. No.: US 2025/0346094 A1
(43) Pub. Date: Nov. 13, 2025

(54) CONVEYANCE ASSEMBLY

(71) Applicant: TS TECH CO., LTD., Asaka-shi, Saitama (JP)

(72) Inventors: Kohei SATO, Tochigi (JP); Ryosuke KOJIMA, Tochigi (JP); Haruka DEJIMA, Tochigi (JP); Yuma TANABE, Tochigi (JP)

(21) Appl. No.: 18/879,944

(22) PCT Filed: Jun. 30, 2023
(86) PCT No.: PCT/JP2023/024481

§ 371 Date: Dec. 30, 2024

Related U.S. Application Data
(60) Provisional application No. 63/357,693, filed on Jul. 1, 2022.

(30) Foreign Application Priority Data
Sep. 30, 2022 (JP) 2022-158402

(51) Int. Cl. B60H 1/34; B60N 2/56

(52) U.S. Cl. CPC B60H 1/3407; B60N 2/5642

(57) ABSTRACT

There is provided a conveyance assembly that can be easily provided in a conveyance cabin, and that can perform efficient air conditioning for an occupant. A conveyance assembly is a conveyance assembly including an interior member provided in a conveyance. The interior member is composed of at least a conveyance seat, the interior member includes an air conditioning device, and the air conditioning device includes a housing, a blowing device accommodated in the housing, and a heating device accommodated in the housing and disposed in a blowing direction of air blown by the blowing device. Since the air conditioning device is unitized, the air conditioning device can be easily provided in the interior member, and can perform efficient air conditioning for an occupant.

### TECHNICAL FIELD

The present invention relates to a conveyance assembly, particularly to a conveyance assembly including an air conditioning device.

### BACKGROUND ART

Conventionally, as described in PATENT LITERATURE 1, a technology in which air heated by a heater is sent from a seat cushion of a vehicle seat toward an occupant has been disclosed.

### CITATION LIST

### Patent Literature

PATENT LITERATURE 1: JP 2022-109791 A

### SUMMARY OF INVENTION

### Technical Problem

However, a specific structure in which an air conditioning device such as a blower or a heater is provided for the seat cushion of the vehicle seat has not been disclosed. In addition, there is no disclosure regarding the connection between an air conditioning device installed in a vehicle seat and an air conditioning device (air conditioner) installed in a vehicle, nor is there disclosure regarding the efficient optimization of air conditioning in a vehicle interior.

The present invention has been made in view of the above-described problems, and an object of the present invention is to provide a conveyance assembly that can be easily provided in a conveyance cabin, and that can perform efficient air conditioning for an occupant.

### Solution to Problem

The above-described problems are solved by a conveyance assembly of the present invention, the conveyance assembly including an interior member provided in a conveyance. The interior member is composed of at least a conveyance seat, the interior member includes an air conditioning device, and the air conditioning device includes a housing, a blowing device accommodated in the housing, and a heating device accommodated in the housing and disposed in a blowing direction of air blown by the blowing device.

According to the above-described configuration, since the air conditioning device includes the housing in which the blowing device and the heating device are accommodated, and is unitized, it is possible to provide the conveyance assembly that can be easily provided in the interior member inside a conveyance cabin, and that can perform efficient air conditioning for an occupant.

In the conveyance assembly described above, it is preferable that a blowing port for discharging the air is formed in the housing of the air conditioning device, and it is preferable that the heating device is provided adjacent to the blowing port.

Since the heating device is provided adjacent to the blowing port, the air can be efficiently heated.

In the conveyance assembly described above, it is preferable that the conveyance seat includes a seat frame serving as a skeleton of the conveyance seat, and it is preferable that the air conditioning device is attached to the seat frame.

Attachment rigidity is improved by attaching the air conditioning device to the seat frame. In addition, since the air conditioning device is close to the occupant seated in the conveyance seat, more efficient air conditioning can be performed.

In the conveyance assembly described above, it is preferable that the seat frame includes a side frame located at a side portion of the conveyance seat, and it is preferable that the air conditioning device is attached to a side surface of the side frame.

Attachment rigidity is improved by attaching the air conditioning device to the side frame, and discomfort felt by the occupant is suppressed by locating the air conditioning device at the side portion of the conveyance seat.

In the conveyance assembly described above, it is preferable that the conveyance seat includes a bolster portion at the side portion of the conveyance seat, and it is preferable that a ventilation hole facing a blowing port of the air conditioning device attached to the side frame is formed in the bolster portion.

By forming the ventilation hole, which faces the blowing port of the air conditioning device, in the bolster portion, the air can be efficiently blown to the occupant.

In the conveyance assembly described above, it is preferable that the conveyance seat includes a seat cushion that supports buttocks of a seated occupant, it is preferable that the seat frame includes a cushion side frame located at a side portion of the seat cushion, and it is preferable that the air conditioning device is attached to the cushion side frame, and blows the air toward a chest region of the occupant.

By attaching the air conditioning device to the cushion side frame, and blowing the air toward the chest region of the occupant, the chest region of the occupant can be efficiently warmed.

In the conveyance assembly described above, it is preferable that the conveyance seat is provided with an attachment portion for attaching another member separate from the air conditioning device, and it is preferable that the air conditioning device is disposed at a position avoiding the attachment portion for the other member. By disposing the air conditioning device at a position avoiding the attachment portion for the other member, hindrance to the attachment of the other member is suppressed.

In the conveyance assembly described above, it is preferable that another member separate from the air conditioning device is attached to the side frame, and it is preferable that the air conditioning device is disposed at a position avoiding the other member attached to the side frame.

By disposing the air conditioning device at a position avoiding the other member, interference of the air conditioning device with the other member is suppressed.

In the conveyance assembly described above, it is preferable that the interior member includes a door lining for a conveyance door, and it is preferable that the air conditioning device is attached to the conveyance door.

By attaching the air conditioning device to the door lining for the conveyance door, the air conditioning device can be disposed close to the occupant, and efficient air conditioning can be performed for the occupant.

In the conveyance assembly described above, it is preferable that the interior member includes a floor member forming a floor of the conveyance, and it is preferable that the air conditioning device is attached to the floor member.

By attaching the air conditioning device to the floor member, the air conditioning device can be located close to the occupant, and efficient air conditioning can be performed for the occupant.

### Advantageous Effects of Invention

According to the conveyance assembly of the present invention, since the air conditioning device includes the housing in which the blowing device and the heating device are accommodated, and is unitized, it is possible to provide the conveyance assembly that can be easily provided in the interior member inside the conveyance cabin, and that can perform efficient air conditioning for the occupant.

In addition, according to the conveyance assembly of the present invention, since the heating device is provided adjacent to the blowing port, the air can be efficiently heated.

In addition, according to the conveyance assembly of the present invention, attachment rigidity is improved by attaching the air conditioning device to the seat frame. In addition, since the air conditioning device is close to the occupant seated in the conveyance seat, more efficient air conditioning can be performed.

In addition, according to the conveyance assembly of the present invention, attachment rigidity is improved by attaching the air conditioning device to the side frame, and discomfort felt by the occupant is suppressed by locating the air conditioning device at the side portion of the conveyance seat.

In addition, according to the conveyance assembly of the present invention, by forming the ventilation hole, which faces the blowing port of the air conditioning device, in the bolster portion, the air can be efficiently blown to the occupant.

In addition, according to the conveyance assembly of the present invention, by attaching the air conditioning device to the cushion side frame and blowing the air toward the chest region of the occupant, the chest region of the occupant can be efficiently warmed.

In addition, according to the conveyance assembly of the present invention, by disposing the air conditioning device at a position avoiding the attachment portion for the other member, hindrance to the attachment of the other member is suppressed.

In addition, according to the conveyance assembly of the present invention, by disposing the air conditioning device at a position avoiding the other member, interference of the air conditioning device with the other member is suppressed.

In addition, according to the conveyance assembly of the present invention, by attaching the air conditioning device to the conveyance door, the air conditioning device can be disposed close to the occupant, and efficient air conditioning can be performed for the occupant.

In addition, according to the conveyance assembly of the present invention, by attaching the air conditioning device to the floor member, the air conditioning device can be disposed close to the occupant, and efficient air conditioning can be performed for the occupant.

### BRIEF DESCRIPTION OF DRAWINGS

FIG. 1 is a perspective view showing an appearance of a conveyance assembly according to one embodiment of the present invention when viewed obliquely from the front.

FIG. 2 is a perspective view showing a seat frame of a conveyance seat and warm air devices when viewed obliquely from the rear.

FIG. 3 is a perspective view showing an appearance of the warm air device.

FIG. 4 is an exploded perspective view showing a configuration of the warm air device.

FIG. 5 is a side view showing an air conditioning device attached to a side frame.

FIG. 6A is a cross-sectional view taken along line VI-VI of FIG. 5, and is a view showing an example of attaching means for attaching the warm air device to the side frame.

FIG. 6B is a cross-sectional view taken along line VI-VI of FIG. 5, and is a view showing another example of attaching means for attaching the warm air device to the side frame.

FIG. 7 is a side view showing another example of the side frame to which the warm air device is attached.

FIG. 8 is a cross-sectional view taken along line VIII-VIII of FIG. 7, and is a view showing a cover attachment portion provided in the side frame.

FIG. 9A is a descriptive view showing air directions from the warm air devices when the conveyance seat is viewed from the front.

FIG. 9B is a descriptive view showing air directions from the warm air devices when the conveyance seat is viewed from the side.

FIG. 10 is a graph showing temperature compensation by the warm air device.

FIG. 11 is a flowchart showing an air conditioning process.

FIG. 12 is a descriptive view showing the position of an air conditioning unit in a conveyance.

FIG. 13 is a descriptive view showing ducts extending from the air conditioning unit in the conveyance.

FIG. 14 is a descriptive view showing a positional relationship between the air conditioning unit and a battery in the conveyance.

FIG. 15A is a descriptive view showing another positional relationship between the air conditioning unit and the battery in the conveyance when the conveyance is viewed from the side.

FIG. 15B is a descriptive view showing another positional relationship between the air conditioning unit and the battery in the conveyance when the conveyance is viewed from the front.

FIG. 16 is a graph showing a relationship between the output of a blower fan and a heater and noise in a conveyance cabin.

FIG. 17A is a descriptive view showing the output of the blower fans when the speed of the conveyance is high.

FIG. 17B is a descriptive view showing the output of the blower fans when the speed of the conveyance is low or the conveyance is stopped.

FIG. 18A is a descriptive view showing a blowing position when the speed of the conveyance is high.

FIG. 18B is a descriptive view showing a blowing position when the speed of the conveyance is low or the conveyance is stopped.

FIG. 19 is a flowchart showing an air conditioning process using information on the number of occupants, seating positions, or the like.

### DESCRIPTION OF EMBODIMENTS

Hereinafter, a configuration of a conveyance assembly according to one embodiment of the present invention will be described with reference to the drawings. However, the embodiment to be described below is provided for easy understanding of the present invention, and does not limit the present invention. Namely, the present invention can be modified or improved without departing from the concept of the present invention, and it goes without saying that the present invention includes equivalents thereof.

In addition, in the following description, the contents regarding the materials, shapes, and sizes of components constituting the conveyance assembly are provided as merely one specific example, and do not limit the present invention.

Incidentally, hereinafter, an assembly installed in a vehicle and composed of interior members including at least a conveyance seat will be taken as one example of the conveyance assembly, and configuration examples thereof will be described.

In addition, in the following description, the “front to rear direction” is a front to rear direction of the conveyance seat, and is a direction that coincides with a traveling direction when the vehicle travels. In addition, the “seat width direction” is a lateral width direction of the conveyance seat, and is a direction that coincides with a right to left direction when viewed from an occupant seated in the conveyance seat. In addition, the “up to down direction” is an up to down direction of the conveyance seat, and is a direction that coincides with a vertical direction when the vehicle travels on a horizontal surface.

Incidentally, in the following description, unless otherwise specified, the shape, position, posture, and the like of each portion of the conveyance seat will be described based on the assumption that the conveyance seat is in a seating state.

### <Conveyance Assembly M>

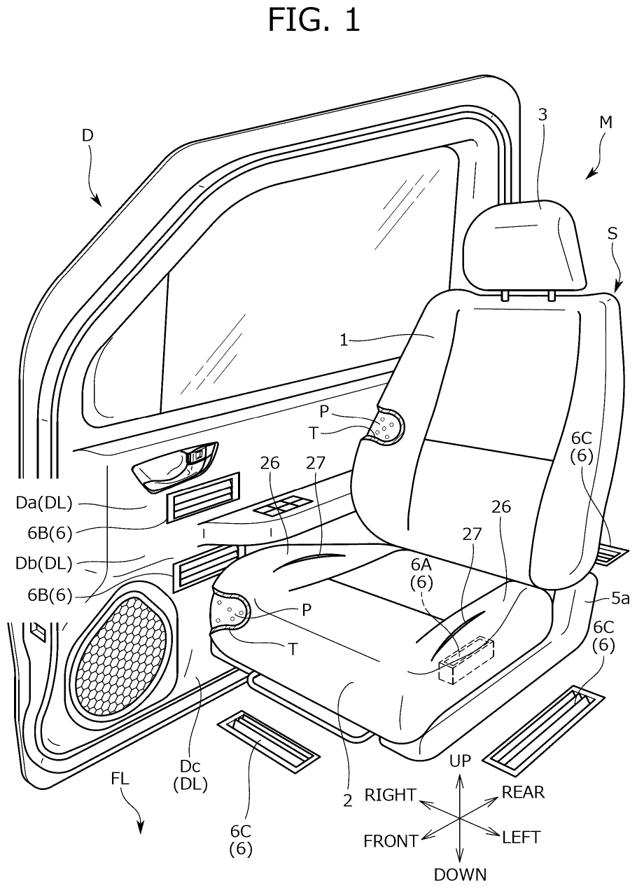

A basic configuration of a conveyance assembly M according to the present embodiment will be described with reference to FIG. 1. The conveyance assembly M is an assembly provided in a vehicle V and including an interior member composed of at least a conveyance seat S. In the present embodiment, the conveyance assembly M includes, as the interior members, a door lining DL for a conveyance door D of the vehicle V, and a floor member FLm constituting a floor FL of the vehicle V, in addition to the conveyance seat S. In addition, each interior member is provided with a warm air device 6 (air conditioning device). Hereinafter, the conveyance seat S, the door lining DL, and the floor member FLm that are interior members will be described, and then a configuration of the warm air device 6 will be described.

### <Conveyance Seat S>

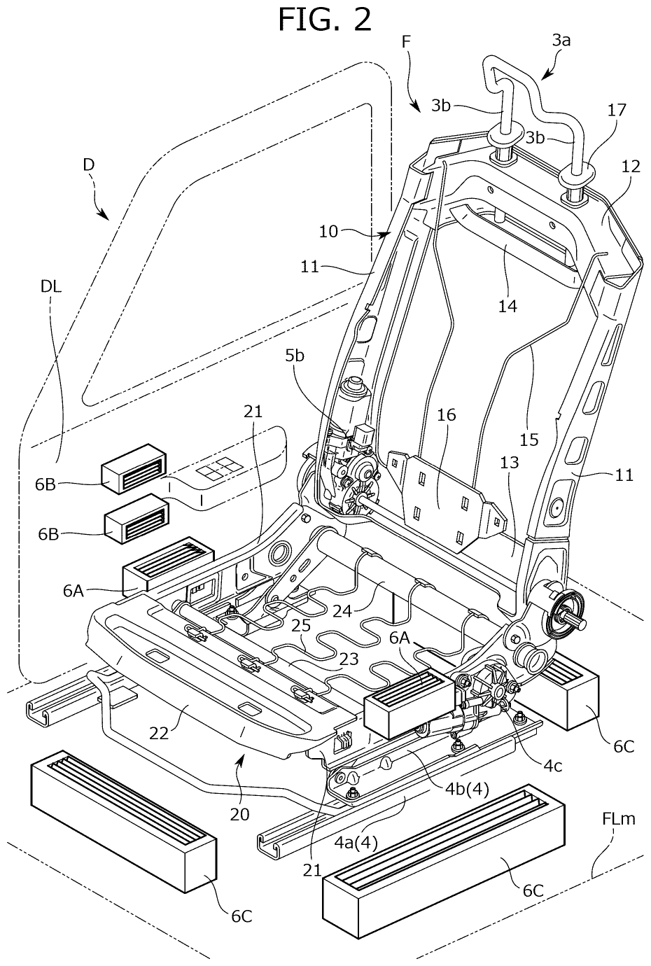

A basic configuration of the conveyance seat will be described with reference to FIGS. 1 and 2. FIG. 1 is a perspective view of the conveyance assembly M including the conveyance seat S, and for convenience of illustration, a part of the conveyance seat S in FIG. 1 is illustrated with a skin material T removed. FIG. 2 is a perspective view showing a seat frame F of the conveyance seat S and the warm air device 6 that is an air conditioning device.

The conveyance seat S is a seat which is placed on the floor FL of the vehicle V, and in which an occupant H (seated occupant) of the vehicle V is seated. In the present embodiment, the conveyance seat S is used as a front seat corresponding to a front seat of the vehicle V. However, the conveyance seat S is not limited thereto, and can also be used as a rear seat, and can also be used as a middle seat in a second row or a rear seat in a third row in a vehicle including three rows of seats in the front to rear direction.

As shown in FIG. 1, the conveyance seat S includes, as main components, a seat back 1 serving as a backrest portion that supports the back of the seated occupant; a seat cushion 2 serving as a seating portion that supports the buttocks of the seated occupant; and a headrest 3 that is disposed on an upper portion of the seat back 1, and that supports the head of the seated occupant. Incidentally, the seat back 1, the seat cushion 2, and the headrest 3 may be collectively referred to as a seat body.

The seat back 1 is configured by placing a pad material P on a seat back frame 10 serving as a skeleton, and covering the pad material P with the skin material T. In addition, the seat cushion 2 is configured by placing the pad material P on a seat cushion frame 20 serving as a skeleton, and covering the pad material P with the skin material T.

The headrest 3 is provided above the seat back 1, and is configured by placing the pad material P on a headrest frame 3a serving as a core material, and covering the pad material P with the skin material T.

The conveyance seat S includes a rail device 4 that supports the seat body so as to be movable in the front to rear direction with respect to the vehicle body floor. The rail device 4 is a device that moves the seat body in a sliding manner along the front to rear direction, and has a known structure (structure of a typical rail device). The rail device 4 includes a lower rail 4a fixed onto the floor FL, and an upper rail 4b that is movable in a sliding manner with respect to the lower rail 4a. In addition, when the rail device 4 is of an electric type, the rail device 4 further includes an actuator 4c, and can slide the upper rail 4b in the front to rear direction through the rotation of a motor of the actuator 4c.

In addition, the conveyance seat S includes a reclining device 5 that tilts the seat back 1 with respect to the seat cushion 2 (refer to FIG. 2). The reclining device 5 is provided between the seat back 1 and the seat cushion 2, and the inclination angle of the seat back 1 with respect to the seat cushion 2 can be adjusted by the reclining device 5.

In addition, when the reclining device 5 is of an electric type, the reclining device 5 further includes an actuator 5b, and can tilt the seat back 1 in the front to rear direction through the rotation of a motor of the actuator 5b.

### <Seat Frame F>

As shown in FIG. 2, the seat frame F is provided inside the conveyance seat S. The seat frame F is mainly composed of the seat back frame 10 forming the skeleton of the seat back 1, and the seat cushion frame 20 forming the skeleton of the seat cushion 2.

### <Seat Back Frame 10>

As shown in FIG. 2, the seat back frame 10 is formed in a rectangular frame shape as a whole, and the seat back frame 10 includes a pair of back side frames 11 and 11 disposed on the right and left; an upper frame 12; and a lower frame 13. The upper frame 12 is disposed between the pair of back side frames 11 and 11, and connects upper ends of the pair of back side frames 11 and 11. The lower frame 13 is disposed between the pair of back side frames 11 and 11, and connects lower ends of the pair of back side frames 11 and 11. In addition, a connecting frame 14 is interposed between both right and left end portions of the upper frame 12 on an upper side of the seat back frame 10.

A pressure-receiving member 16 is disposed below the connecting frame 14. The pressure-receiving member 16 is connected to the connecting frame 14 via wire members 15. The pressure-receiving member 16 is a plate member having flexibility, and supports the back of the seated occupant from the rear. The pressure-receiving member 16 is made of resin, but is not limited thereto. The pressure-receiving member 16 may be made of metal.

The upper frame 12 is provided with pillar support portions 17 into which headrest stays 3b of the headrest 3 are inserted. The pillar support portions 17 are formed as members made of a high-strength metal to maintain the holding strength of the headrest 3 and to suppress looseness of the headrest 3. Incidentally, the pillar support portions 17 are not limited to being made of metal, and may be made of resin.

The pair of back side frames 11 and 11 are members that are disposed on the right and left of the seat back frame 10 as described above and that are basically configured to be bilaterally symmetric. The pair of back side frames 11 and 11 are members extending in the seat up to down direction, and the width of each of the pair of back side frames 11 and 11 in the seat front to rear direction is formed to increase as each of the pair of back side frames 11 and 11 extends from an upper side of the seat toward a lower side of the seat.

### <Seat Cushion Frame 20>

As shown in FIG. 2, the seat cushion frame 20 is formed in a rectangular frame shape when viewed from below, and a pair of cushion side frames 21 and 21 are provided on the right and left of the seat cushion frame 20. The pair of cushion side frames 21 and 21 are members extending in the seat front to rear direction, and are basically configured to be bilaterally symmetric. The pair of cushion side frames 21 and 21 are disposed to be separated from each other in the right to left direction in order to define the width of the seat cushion frame 20.

In addition, the seat cushion frame 20 includes a pan frame 22 located at a front end portion of the seat cushion frame 20; a front connecting frame 23 that connects the pair of cushion side frames 21 and 21 at the front; and a rear connecting frame 24 that connects the pair of cushion side frames 21 and 21 at rear end portions. The front connecting frame 23 and the rear connecting frame 24 are made of round pipes.

The pan frame 22 is mainly for supporting the thighs of the seated occupant (occupant H), and is a frame made of a metal plate. The pan frame 22 is fixedly joined to a front side of the right and left cushion side frames 21 and 21, and the right and left cushion side frames 21 and 21 are connected to each other on the front side by the pan frame 22.

Front ends of the support members 25 are locked to the front connecting frame 23, and rear ends of the support members 25 are locked to the rear connecting frame 24. The support members 25 are spring members having flexibility and capable of supporting the seated occupant by receiving the load of the seated occupant from below.

### <Headrest 3>

The headrest 3 is attached to the upper portion of the seat back 1 to support the head of the seated occupant. The headrest frame 3a forming the skeleton of the headrest 3 is provided inside the headrest 3, and two headrest stays 3b (also referred to as headrest pillars) hanging down from a lower portion of the headrest 3 are provided at both right and left ends of the headrest frame 3a. By inserting the headrest stays 3b into the pillar support portions 17 attached to the upper frame 12 of the seat back frame 10, the headrest 3 is attached to the seat back frame 10.

### <Door Lining DL>

The door lining DL of the conveyance door D will be described. The conveyance door D is provided with the door lining DL that is an interior member constituting the conveyance assembly M. The door lining DL is a member provided on a vehicle cabin side of the conveyance door D for the purpose of interior decoration or the like, the conveyance door D being supported by the vehicle V to be openable and closeable, is formed from, for example, a synthetic resin, and has not only the function of interior decoration, but also the function of a member for sound insulation, sound absorption, and protection of occupants in the event of a collision.

As shown in FIG. 1, the door lining DL includes an upper portion Da, a center portion Db, and a lower portion Dc, and the upper portion Da, the center portion Db, and the lower portion Dc are connected to each other to form the door lining DL.

The upper portion Da is equipped with door opening and closing knob and the like, and a speaker or a door pocket is provided at the front of the lower portion Dc. In addition, an armrest is provided in the center portion Db. The armrest is provided with a power window switch that raises and lowers windows and the like.

### <Floor Member FLm>

The floor member FLm constituting the floor FL of the vehicle V will be described. The floor member FLm having a plate shape is provided on the floor FL, and the floor member FLm is supported by a frame (not illustrated) constituting a vehicle body. When the vehicle V is an electric vehicle, batteries B may be disposed under the floor member FLm.

### <Warm Air Device 6>

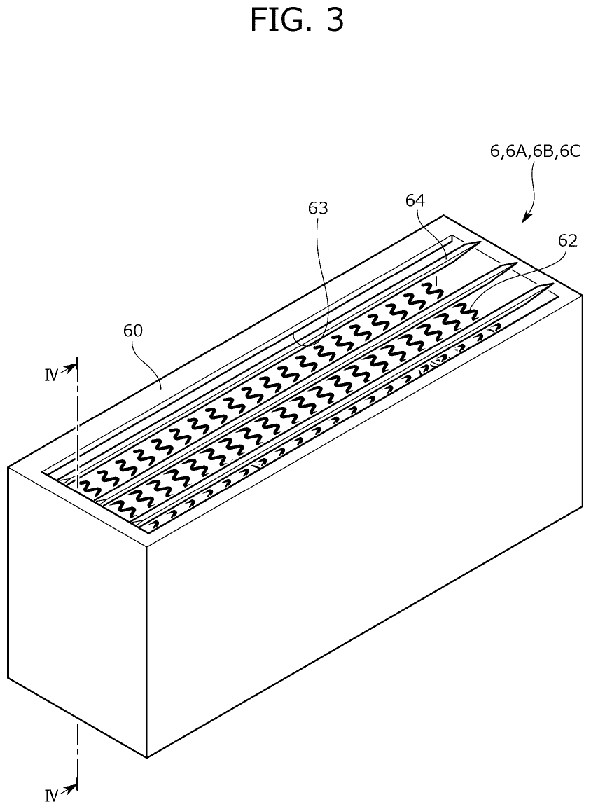

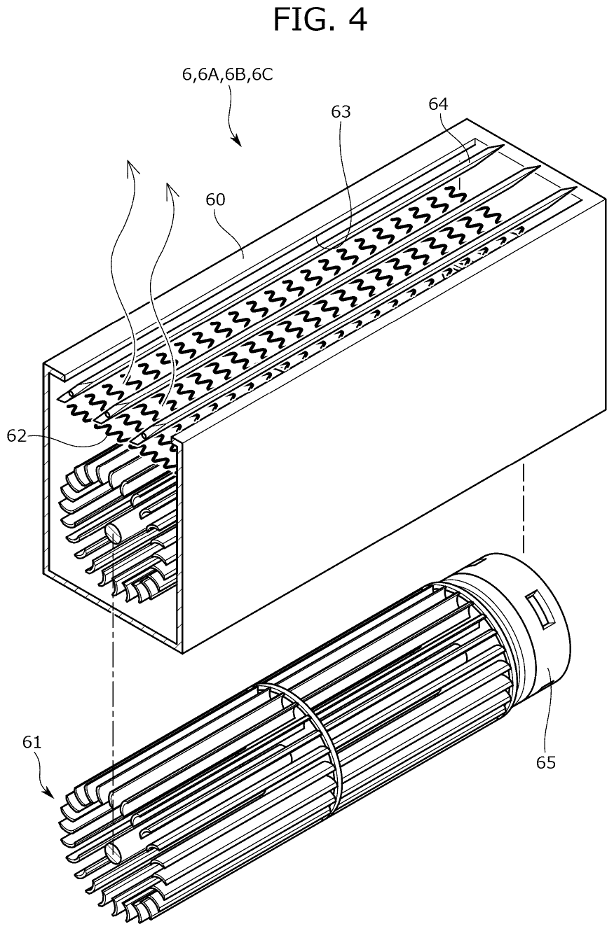

A configuration of the warm air device 6 provided in the conveyance assembly M will be described with reference to FIGS. 3 and 4. The warm air device 6 is a replaceable unit that is built into, for example, the conveyance seat S, and that sends out warm air toward the seated occupant H through ventilation holes 27 formed in the conveyance seat S.

The warm air device 6 includes a housing 60 having an elongated quadrangular prism shape, and includes a sirocco fan 61 (blowing device) accommodated in the housing 60, and a heater 62 (heating device) accommodated in the housing.

The sirocco fan 61 is a fan that changes the flow direction of air, is also referred to as a “multi-blade blower”, and is a blowing device in which many blades are attached in a rotation direction. As shown in FIG. 4, blades having longitudinally elongated plate shape are attached in a tubular shape, and the blades are configured to be rotated by a motor 65 to suction air and discharge the air toward a blowing port 63 of the housing 60.

The heater 62 is provided in a blowing direction of the sirocco fan 61, and warms the air sent to the heater 62.

In addition, the blowing port 63 that opens along a longitudinal direction of the housing 60 is formed in the housing 60, and the blowing port 63 is provided with louver 64 that changes the direction of air.

As shown in FIG. 4, the heater 62 is provided adjacent to the blowing port 63. Accordingly, the air sent out from the sirocco fan 61 can be efficiently heated.

In addition, the warm air device 6 is connected, via a harness, to an electronic control unit (ECU) (not illustrated) that controls electronic devices installed in the vehicle, and can change the rotation speed of the sirocco fan 61 and the temperature of the heater 62 by receiving control signals from the ECU. In addition, the direction of the louver 64 can be manually changed; however, a motor may be provided, and the direction of the louver 64 may be automatically changed in response to a control signal from the ECU.

The sirocco fan 61 is provided in the warm air device 6 as a blowing device; however, the blowing device is not limited to the sirocco fan 61, and may be another type of a blowing device, for example, an axial fan.

The warm air device 6 is configured as a replaceable unit, and can be attached not only inside the conveyance seat S, but also to other interior members. Hereinafter, an attachment position where the warm air device 6 is attached will be described.

### <Attachment Position of Warm Air Device 6>

The warm air devices 6 are attached to the seat frame F of the conveyance seat S similarly to warm air devices 6A shown in FIG. 2. In more detail, the warm air devices 6A are attached to side surfaces of the cushion side frame 21 located at side portions of the seat cushion 2.

In addition, as shown in FIG. 1, bolster portions 26 are provided at side portions of the conveyance seat S, and the warm air devices 6A are disposed inside the bolster portions 26. The ventilation holes 27 are formed in the bolster portions 26 to face the blowing ports 63 of the warm air devices 6A, and warm air discharged from the warm air devices 6A can be sent toward the occupant. In the present embodiment, the louvers 64 of the warm air devices 6A and the ventilation holes 27 are disposed to blow warm air toward the chest region of the occupant.

Attachment rigidity is improved by attaching the warm air device 6 to the seat frame F. Since the warm air device 6 is close to the occupant H seated in the conveyance seat S, more efficient air conditioning can be performed. In addition, since the warm air device 6 is attached to the side portion of the conveyance seat S, discomfort felt by the occupant H is suppressed. In addition, by forming the ventilation hole 27 in the bolster portion 26 so as to face the blowing port 63 of the warm air device 6, air can be efficiently blown to the occupant H. Particularly, the chest region of the occupant H can be efficiently warmed by blowing air toward the chest region of the occupant H.

### <Method for Attaching Warm Air Device 6>

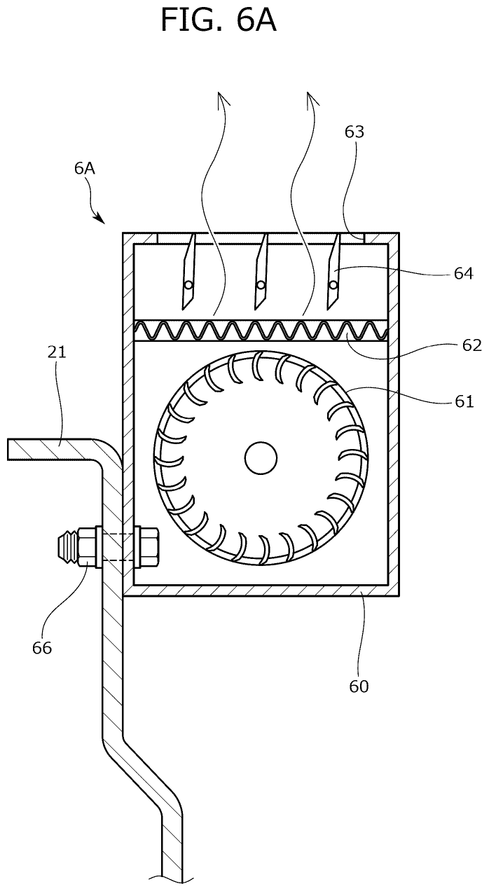

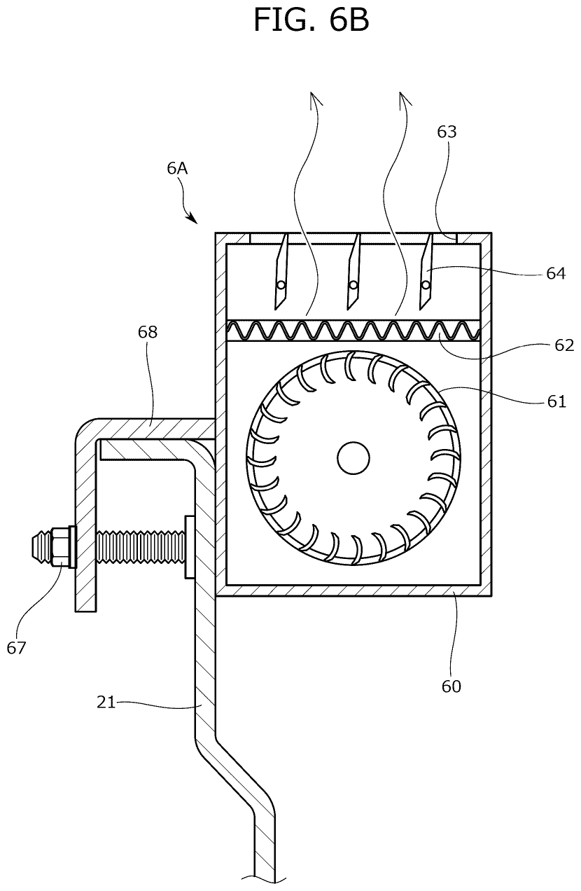

As shown in FIG. 6A, the warm air device 6A is attached to the cushion side frame 21 by a bolt 66.

In addition, as shown in FIG. 6B, an attachment portion 68 extending from the side portion may be provided on the housing 60 of the warm air device 6A, and the warm air device 6A may be fixed by a fastener 67.

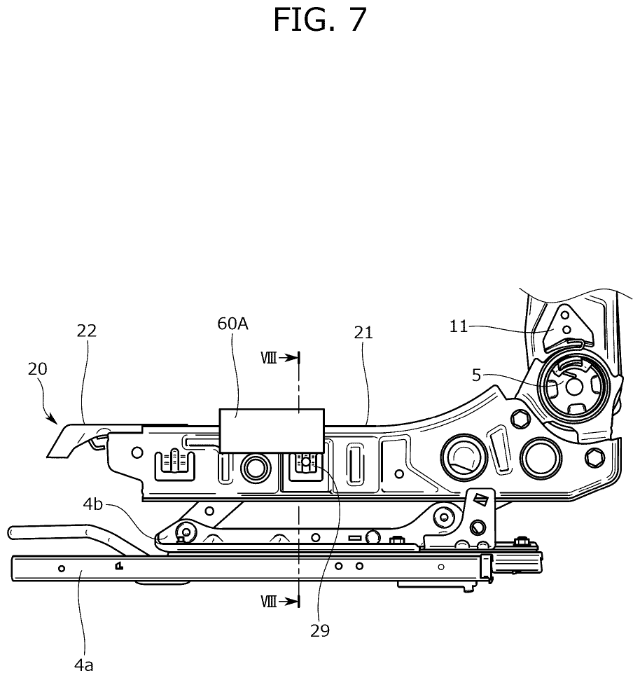

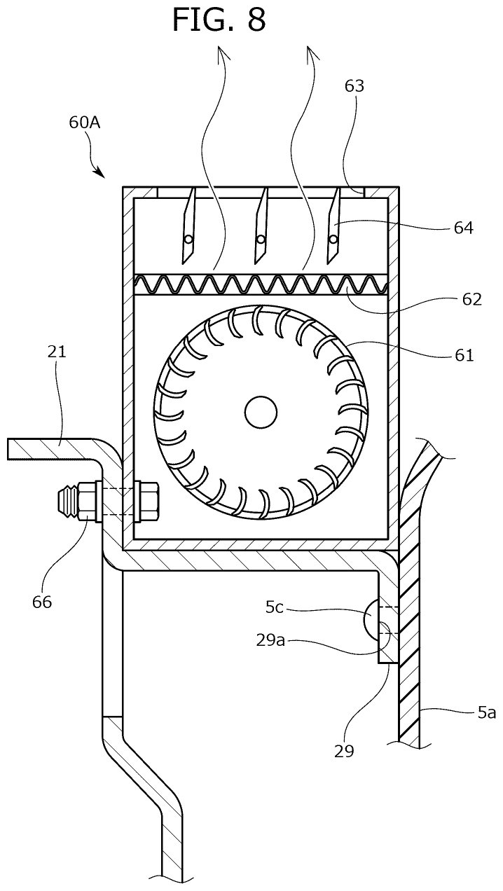

Incidentally, as shown in FIGS. 7 and 8, the cushion side frame 21 may be provided with a cover attachment seat 29 for attaching a reclining device cover 5a. The cover attachment seat 29 is formed by cutting and raising a part of the cushion side frame 21, and a cover attachment hole 29a into which an engagement portion 5c protruding from the reclining device cover 5a is inserted is formed at a tip of the cover attachment seat 29. The reclining device cover 5a can be easily attached by inserting the engagement portion 5c into the cover attachment hole 29a.

As shown in FIGS. 7 and 8, the warm air device 6A is disposed at a position avoiding the cover attachment seat 29 for attaching the reclining device cover 5a that is another member separate from the warm air device 6A. Hindrance to the attachment of the reclining device cover 5a is suppressed by disposing the warm air device 6A at the avoiding position.

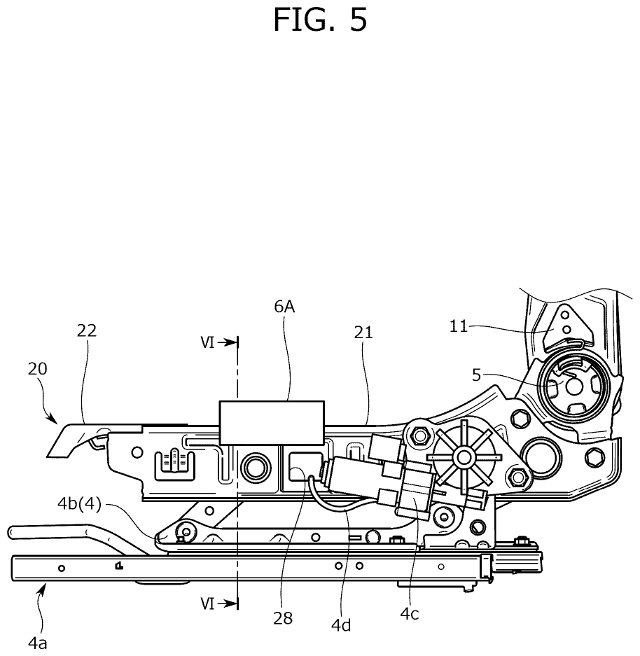

In addition, as shown in FIG. 5, when the rail device 4 is of an electric type, the actuator 4c is provided on the cushion side frame 21, and the warm air device 6A is disposed at a position avoiding the actuator 4c. By disposing the warm air device 6A at a position avoiding the actuator 4c that is another member other than the warm air device 6A, which is attached to the cushion side frame, interference of the warm air device 6A with the other member is suppressed. In addition, when a harness through hole 28 through which a harness 4d connected to the actuator 4c passes is formed in the cushion side frame 21, the warm air device 6A is disposed at a position avoiding the harness through hole 28.

In addition, when a vertical bead is formed at the front of the cushion side frame 21, it is desirable that the warm air device 6A is attached at a position avoiding the vertical bead. Accordingly, interference of the warm air device 6A with the vertical bead is suppressed.

The warm air devices 6 may be attached not only to the conveyance seat S, but also to the door lining DL similarly to warm air devices 6B shown in FIGS. 1 and 2. In the present embodiment, one warm air device 6B is provided at each of the upper portion Da and the lower portion Dc of the door lining DL. The warm air device 6 may be provided at the center portion Db of the door lining DL or in the armrest. At this time, the blowing ports 63 of the warm air devices 6B are disposed to face the interior side.

The warm air devices 6B are disposed close to the occupant H seated in the conveyance seat S, so that efficient air conditioning can be performed for the occupant H. In addition, the occupant H can be quickly heated by operating the warm air devices 6B in combination with the warm air devices 6A of the conveyance seat S.

In addition, the warm air devices 6 may be attached to the floor member FLm constituting the floor FL, similarly to warm air devices 6C shown in FIGS. 1 and 2. In the present embodiment, the warm air devices 6C are disposed to be located in front of, behind, and beside the conveyance seat S. Efficient air conditioning can be performed for the seated occupant by blowing warm air flowing from bottom to top. The occupant H can be quickly heated by operating the warm air devices 6C in combination with the warm air devices 6A of the conveyance seat S.

In addition, the warm air devices 6 may be attached to the back side frames 11 of the seat back 1. Ventilation holes may be provided in bolster portions of the seat back 1, and air may be able to be blown to the occupant from the ventilation holes.

### <Air Conditioning Method>

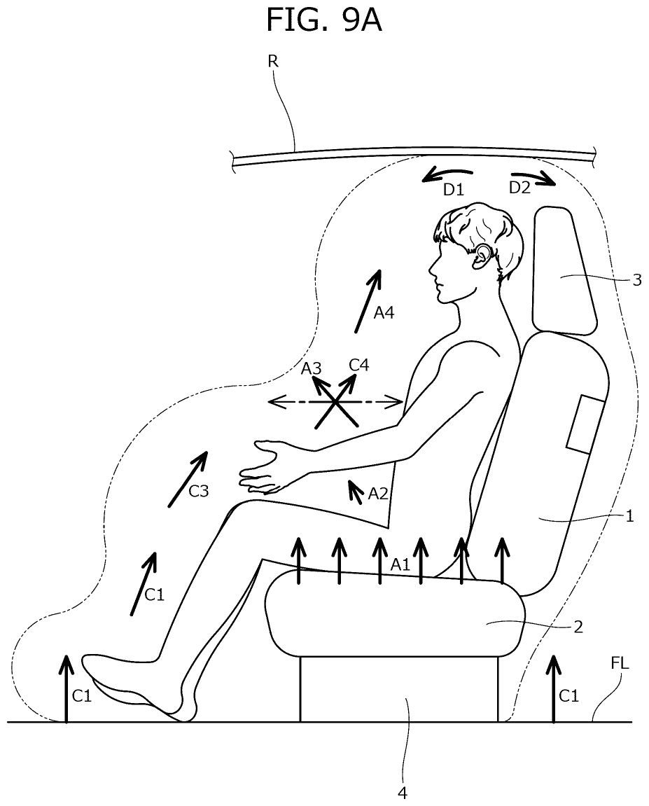

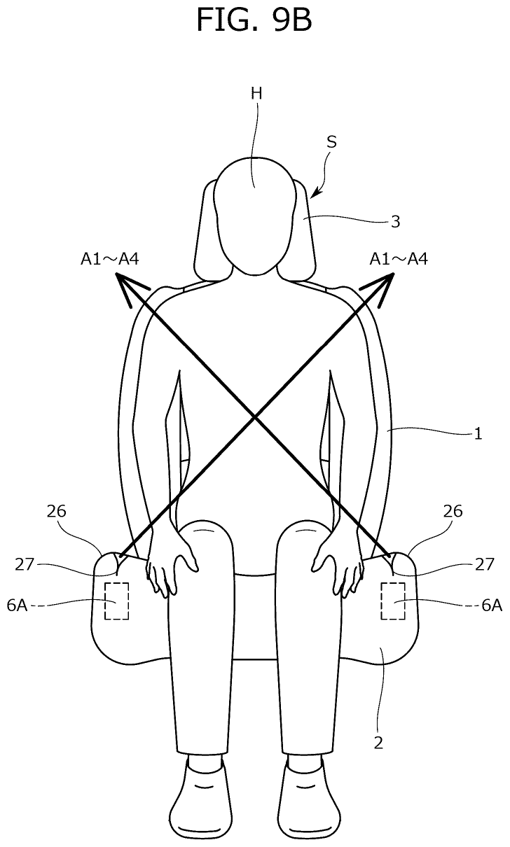

Hereinafter, an air conditioning method using the warm air devices 6 will be described. In the present embodiment, the warm air devices 6 are provided in the conveyance seat, the door lining DL of the conveyance door, and the floor member FLm of the floor. Warm air flowing in a down to up direction (arrows C1 to C4 in FIG. 9A) can be sent out from the warm air devices 6C of the floor member FLm.

In addition, as shown in FIG. 9B, warm air flows can be sent out from the warm air devices 6A of the bolster portions 26 to the seated occupant to intersect each other in the chest region (arrows A1 to A4 in FIGS. 9A and 9B). Accordingly, the warm air flows collide with each other around the abdomen or chest of the occupant, and the air can be diffused around the occupant H even when there is no obstruction such as a wall around the occupant.

In addition, as shown in FIG. 9A, when warm air accumulates in an upper portion of the vehicle interior, the warm air spreads along the shape of a roof R (arrows D1 and D2). In such a manner, the warm air can be diffused by using the properties of air and the shape of the conveyance.

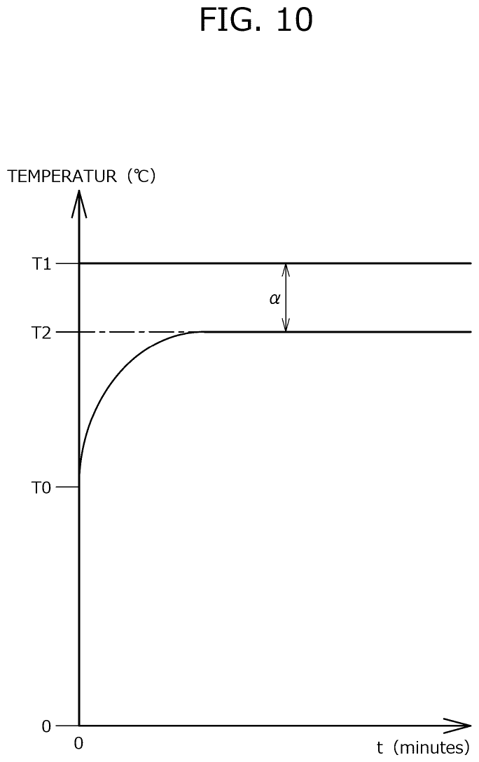

In addition, an optimal temperature space suitable for each occupant can be formed through an energy-saving operation by a combination of the warm air devices 6 and a vehicle air conditioner 70 provided in the vehicle V. For example, as shown in FIG. 10, when a required temperature T1 is set by the occupant H, the temperature achieved by the vehicle air conditioner 70 of the vehicle V is set as a base temperature T2, and a deviation temperature a that is not achieved by the vehicle air conditioner 70 is compensated for by the warm air devices 6. For example, when the required temperature T1 is set to 27 degrees, the output of the vehicle air conditioner 70 is set such that the interior temperature becomes 23 degrees, and a shortfall of 4 degrees that is the deviation temperature α is compensated for by the warm air devices 6. Since only the periphery of the occupant H is warmed by the warm air devices 6, air conditioning can be performed with reduced electric power consumption.

In addition, even when a plurality of occupants having different temperature preferences are seated, the temperature in the vicinity of each occupant can be fine-adjusted. The output of the vehicle air conditioner 70 of the vehicle V may be set to achieve the base temperature T2 (lower than the required temperature T1) that is a base, and the vehicle air conditioner 70 may not perform a high-output operation. Since it can be expected that the temperature of a heater core in the vehicle air conditioner 70 is lowered or the output of a blower is reduced, an energy-saving operation can be performed.

In the vehicle V, in addition to the vehicle air conditioner 70 and the warm air devices 6, door heaters, seat heaters, a steering wheel heater provided in a steering wheel, and the like may be provided (hereinafter, the warm air devices 6, the door heaters, the seat heaters, the steering wheel heater, and the like will be referred to as nearby air conditioning devices). It is preferable that the ECU installed in the vehicle V shares information such as interior temperature, remaining battery charge, operating status, and the number of occupants to cause an operation to be performed with maximum electric power efficiency.

Incidentally, the ECU is a control device, and is a computer including a CPU as a data computation and control processing unit; a ROM and a RAM as storage devices; and a communication interface for sending and receiving a control command or data through an onboard network.

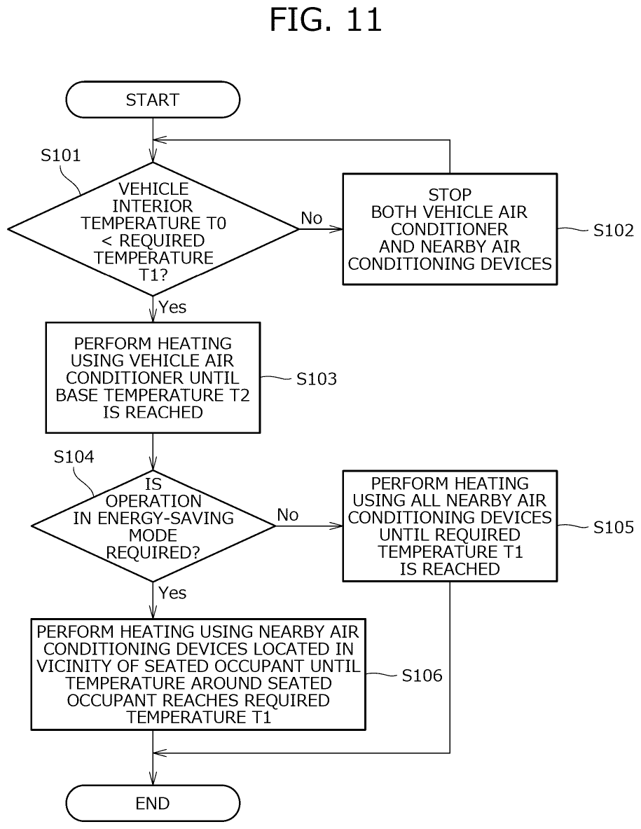

An air conditioning process for efficiently performing air conditioning while taking into account the electric power of the battery will be described with reference to FIG. 11.

When the required temperature T1 is input by the occupant, a vehicle interior temperature T0 and the required temperature T1 are compared to each other (step S101). When the vehicle interior temperature T0 is higher than the required temperature T1 (step S101: No), the vehicle air conditioner 70 and the nearby air conditioning devices including the warm air devices 6 are stopped, and the vehicle interior temperature T0 and the required temperature T1 are continuously monitored (step S102).

When the vehicle interior temperature T0 is lower than the required temperature T1 (step S101: Yes), the interior is heated by the vehicle air conditioner 70 until the base temperature T2 is reached (step S103).

At this time, it is determined whether an operation in an energy-saving mode is required, based on the remaining battery charge or the number of occupants (step S104). When it is determined that the operation in an energy-saving mode is not required (step S104: No), the interior is heated using all the nearby air conditioning devices including the warm air devices 6 until the required temperature T1 is reached (step S105). Accordingly, a comfortable temperature can be reached more quickly.

When the ECU determines that the operation in an energy-saving mode is required (step S104: Yes), heating is performed using only the warm air devices 6 of the seat in which the occupant is seated, which can perform heating most efficiently (step S106). In such a manner, by using the warm air devices 6 and the like installed in the vehicle V, efficient air conditioning can be performed while taking into account the remaining battery charge and the like.

### Second Embodiment

A second embodiment of the present invention will be described with reference to the drawings. Conventionally, as disclosed in JP 2020-147109 A, a configuration in which an air conditioning unit is disposed at the front of a vehicle has been known. However, since the air conditioning unit is disposed at the front of the vehicle cabin, air temperature-adjusted air is not efficiently delivered to rear seats.

An object of the second embodiment is to reduce heat loss and improve air conditioning in a vehicle interior by changing the location where an air conditioner is disposed.

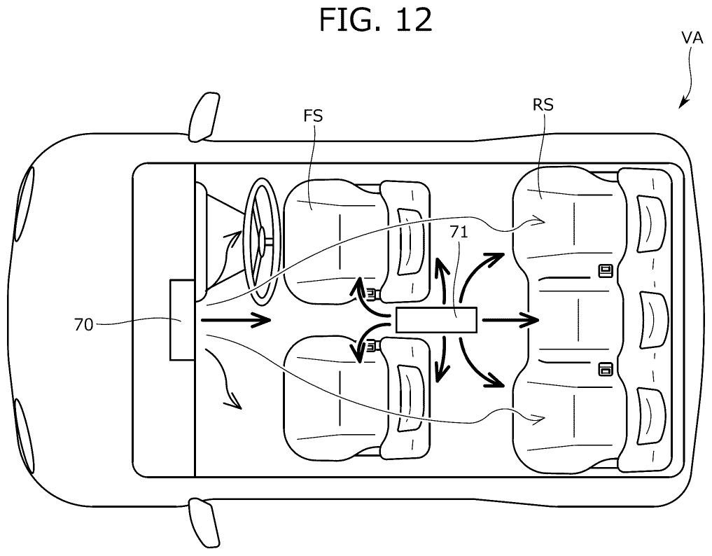

FIG. 12 is a view showing the position of an air conditioning unit 71 in a vehicle VA of the second embodiment. Conventionally, the vehicle air conditioner 70 is provided only at the front of a vehicle body. For that reason, temperature-adjusted air is easily delivered to a front seat FS located close to the vehicle air conditioner 70; however, it is difficult for the temperature-adjusted air to reach a rear seat RS since the vehicle air conditioner 70 is far away therefrom.

In view of such problems, in the present embodiment, the air conditioning unit 71 is disposed between the front seat FS and the rear seat RS, and air conditioning can be performed at a position close to both the front seat FS and the rear seat RS. Since the air conditioning unit 71 is disposed at the center of the interior, heat loss due to being separated from the air conditioner is reduced, and a negative factor of distance when the entirety of the vehicle interior is air-conditioned is eliminated. Accordingly, the amount of electric power required to air-condition the entirety of the vehicle interior can be reduced.

In a conventional gasoline vehicle, since exhaust heat from an engine is used for heating, no electric power is used to produce warm air. However, in the case of an electric vehicle, since there is no engine to warm air, it is necessary to use electric power to produce warm air. For that reason, the use of electric power causes a reduction in range, particularly in winter.

As in the present embodiment, by disposing the air conditioning unit 71 at the center of the interior, the amount of electric power required to air-condition the entirety of the vehicle interior can be reduced, and a reduction in range can be suppressed.

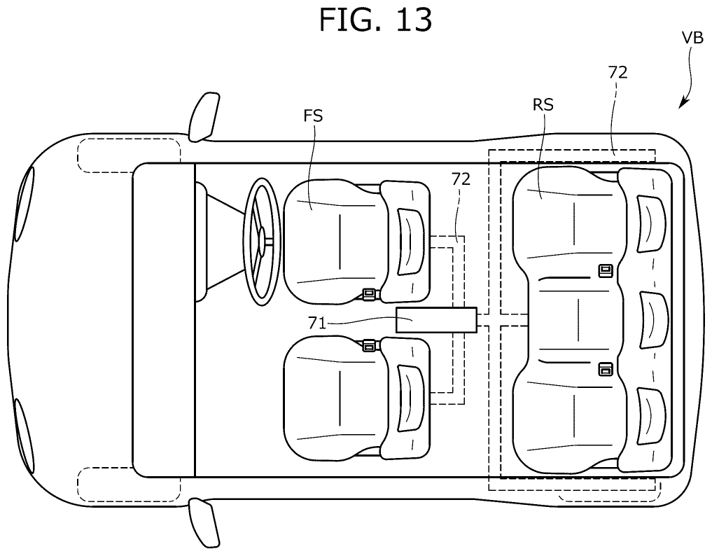

In addition, as in a vehicle VB shown in FIG. 13, ducts 72 that connect the air conditioning unit 71 disposed at the center of the interior and each seat may be provided. Conventionally, seat heaters or the like are secured as heat sources separate from air conditioners. The distance between both the front seat FS and the rear seat RS and the air conditioning unit 71 is short, and the front seat FS and the rear seat RS are easy to access, so that it is easy to connect the front seat FS and the rear seat RS to the ducts, and warm or cool heat can be supplied.

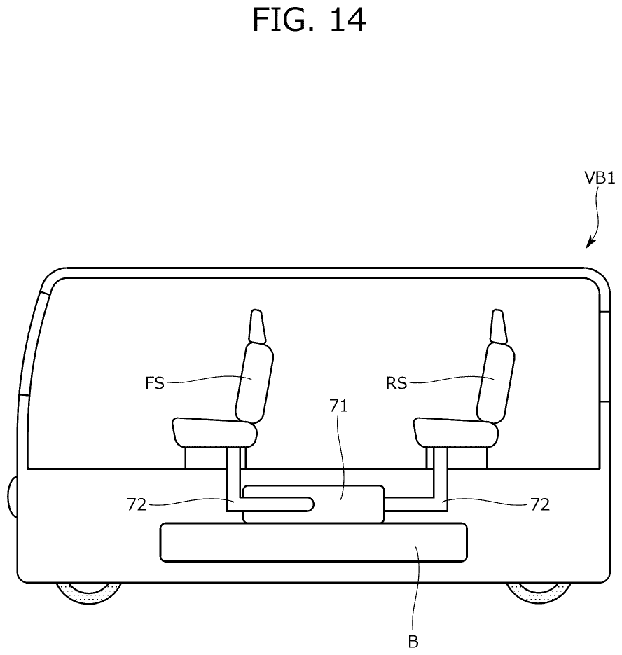

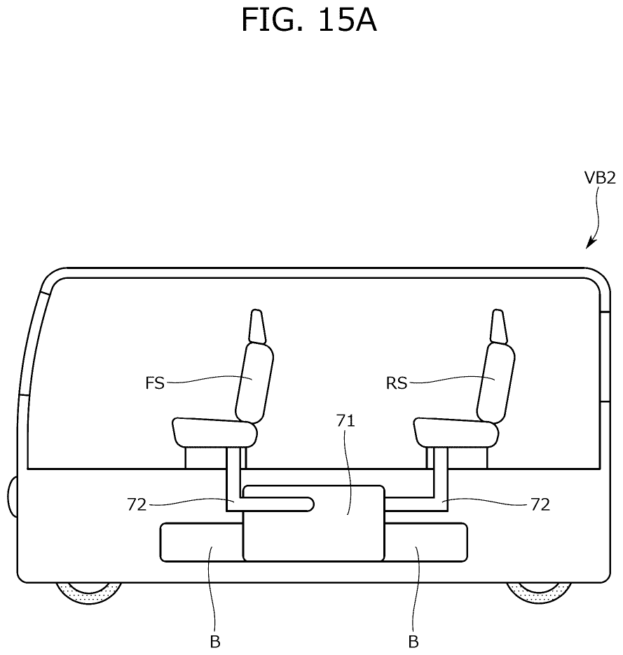

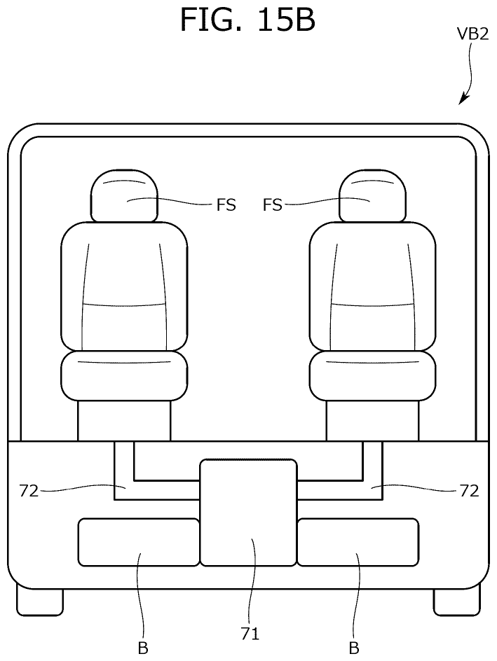

In addition, the air conditioning unit 71 and the ducts 72 are provided under the floor as shown in FIGS. 14 to 15B. As in a vehicle VB1 shown in FIG. 14, the air conditioning unit 71 may be disposed above the batteries B. In addition, as in a vehicle VB2 shown in FIGS. 15A and 15B, the air conditioning unit 71 may be provided under the floor, and the batteries B may be disposed in front of, behind, and to the right and left of the air conditioning unit 71. By disposing the air conditioning unit 71 between the batteries B, the height of the floor surface can be suppressed to a low level.

### Third Embodiment

A third embodiment of the present invention will be described with reference to the drawings. Conventionally, as disclosed in JP 2020-121718 A, a technology in which blowers are provided at an upper portion of a seat back and a lower portion of a seat cushion has been known. The comfort of an occupant is improved by using a warming and cooling device using a blower fan.

However, since the blower provided in the seat back generates noise such as noise due to operation or wind noise, when road noise due to traveling is low (vehicle speed is low) or when the vehicle is stopped, the occupant may feel discomfort due to operational noise. Further, with the recent trend toward the electrification of automobiles, noise generated from surroundings such as a vehicle body has been reduced, operational noise of an air conditioner and a seat air conditioning device becomes even more of a problem.

In the present embodiment, discomfort caused by noise is reduced by connecting the output of a warming and cooling device using a blower fan and the vehicle speed.

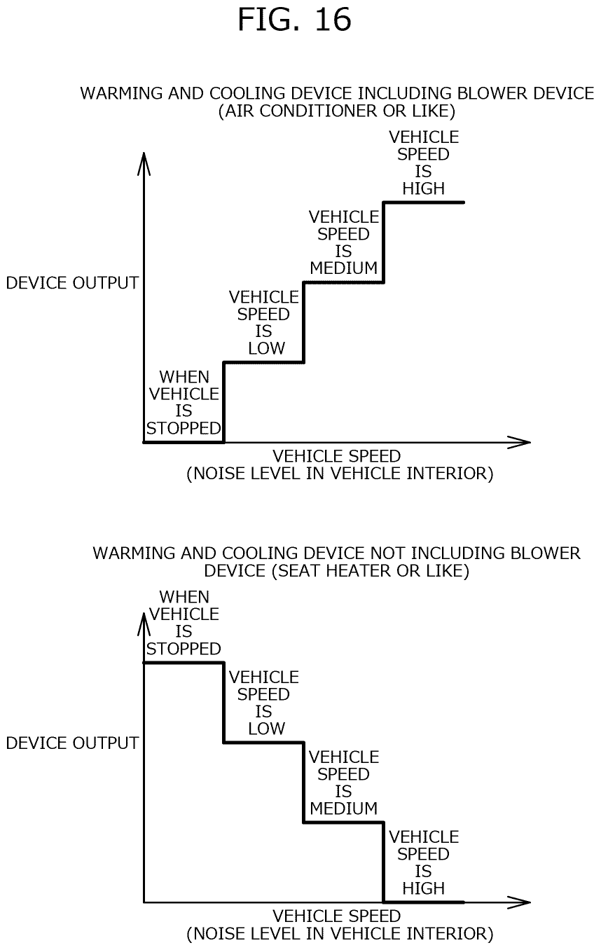

The upper part of FIG. 16 is a graph showing a relationship between the device output and the vehicle speed when a warming and cooling device including a blower device is used. The lower part of FIG. 16 is a graph showing a relationship between the device output and the vehicle speed when a warming and cooling device not including a blower device is used.

As shown in the upper part of FIG. 16, when the vehicle is stopped or the vehicle speed is low, noise is reduced by stopping or reducing the device output of the warming and cooling device including a blower device such as an air conditioner. Accordingly, an increase in discomfort is suppressed. As the vehicle speed increases, noise of the warming and cooling device becomes less annoyed, so that comfort can be improved by increasing the output of the warming and cooling device.

Meanwhile, as shown in the lower part of FIG. 16, when the vehicle is stopped or the vehicle speed is low, a decrease in the comfort of the occupant H is suppressed by increasing the device output of a seat heater or the like not including a blower device.

Incidentally, in the case of a warming and cooling device that does not generate noise, when there is also sufficient electric power available, the warming and cooling device may maintain a constant high output regardless of the vehicle speed.

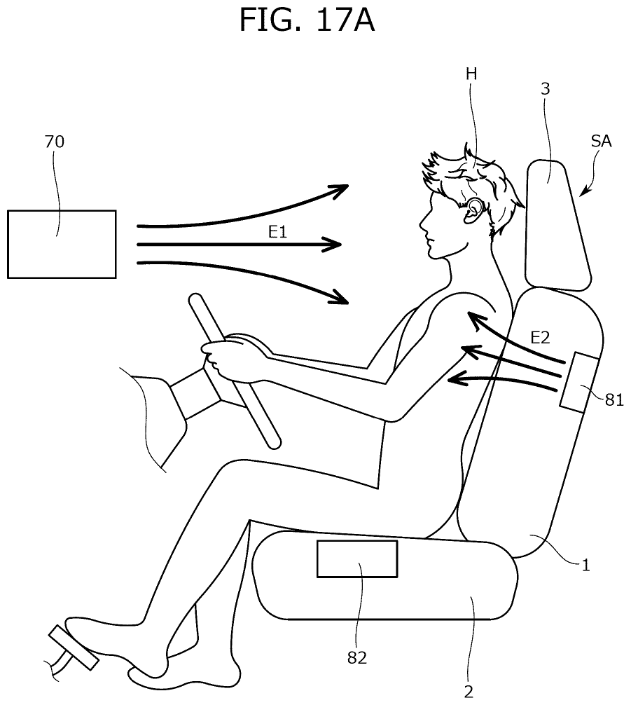

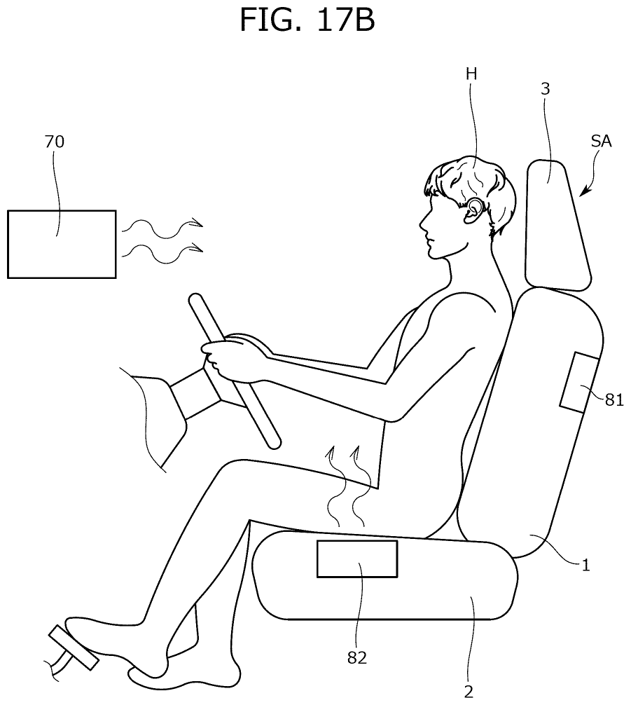

In addition, as in a conveyance seat SA shown in FIGS. 17A and 17B, the seat back 1 may be provided with a back-side blower fan 81, and the seat cushion 2 may be provided with a cushion-side blower fan 82.

In such a case, the output control of the air conditioner and the seat fans may be performed according to the noise level in a vehicle interior space or the vehicle speed.

Specifically, as shown in FIG. 17A, when the vehicle speed is high, the noise level caused by the vehicle is also high, so that the back-side blower fan 81 provided in the seat back 1 is used.

The comfort of the occupant H can be improved by air from the vehicle air conditioner 70 (arrow E1 in FIG. 17A) and air from the back-side blower fan 81 (arrow E2 in FIG. 17A). In addition, since the noise level caused by the vehicle is high, noise of the vehicle air conditioner 70 with a high noise level or the back-side blower fan 81 close to the human body does not become annoyed, and comfort is maintained even when the output thereof is set high.

When the vehicle speed is low or the vehicle is stopped, switching is made to a blower fan disposed at a position far from the ears of the occupant, namely, the cushion-side blower fan 82 provided in the seat cushion 2, or the output thereof is adjusted. The output of the vehicle air conditioner 70 and the back-side blower fan 81 of the seat back 1 may be reduced.

When the vehicle speed is low or the vehicle is stopped, the noise level is low, so that accordingly, the output of the vehicle air conditioner 70 or the back-side blower fan 81 is set low, and the output of an air conditioning system far from the human body (the cushion-side blower fan 82 of the seat cushion 2, a door air conditioning device, a steering wheel heater, or the like) is increased.

Incidentally, since it is difficult for the operational noise of a blower fan far from the ears of the occupant to reach the ears, the blower fan may be used at a constant output regardless of the vehicle speed.

Incidentally, the control of the air conditioning devices such as the vehicle air conditioner 70 and the blower fans may be performed not only based on the vehicle speed but also based on an actual noise level obtained by acquiring a vehicle interior noise level.

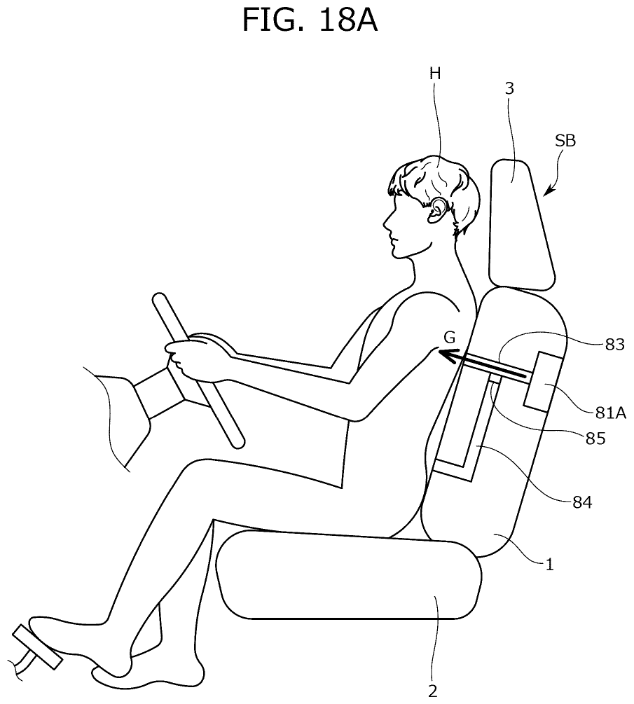

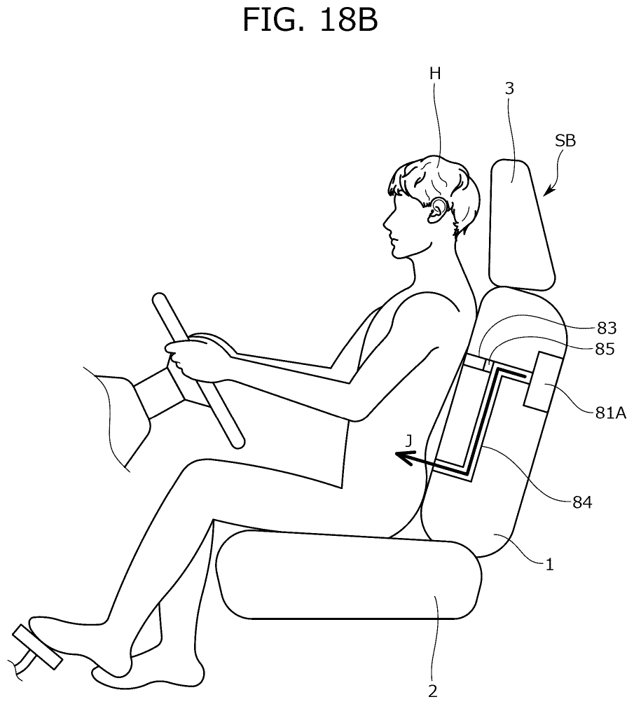

As in a conveyance seat SB shown in FIGS. 18A and 18B, when the seat back 1 is provided with a back-side blower fan 81A, an upper portion-side duct 83 that sends air to the upper portion of the seat back 1 and a lower portion-side duct 84 that sends air to a lower portion of the seat back 1 may be provided, and the duct to be used for blowing air may be switched by an electromagnetic valve 85. By switching the blowing position according to the vehicle speed using the electromagnetic valve 85, discomfort caused by noise is reduced.

Namely, when the speed is high, the electromagnetic valve 85 is set such that air passes through the upper portion-side duct 83 to be blown from the upper portion of the seat back 1 (arrow G in FIG. 18A). In addition, when the vehicle speed is low or the vehicle is stopped, the electromagnetic valve 85 is used for switching to using the lower portion-side duct 84 such that air is blown from the lower portion of the seat back 1 (arrow J in FIG. 18B). When the speed is high, discomfort is low even when the blowing position is close to the ears. Meanwhile, when the vehicle speed is low and the operational noise is noticeable, discomfort can be reduced by blowing air from a position far from the ears.

### Fourth Embodiment

A fourth embodiment of the present invention will be described with reference to the drawings. Conventionally, as described in JP 2020-147109 A, a technology in which temperature-adjusted air is sent from the front of a vehicle to perform air conditioning for the interior. However, since air conditioning for the entire interior of the vehicle is performed, the efficiency is poor.

Therefore, in the present embodiment, only occupants seated in the conveyance seats are detected, and efficient air conditioning is performed such that the occupants feel local warming or cooling.

In the present embodiment, the number of occupants is detected using seat belt reminders provided in conveyance seats, an in-vehicle camera, a human sensor, or the like. Furthermore, depending on the number of occupants, the electric power consumption of the warming and cooling device such as an air conditioner is increased to create a comfortable space in a short period of time. For example, when only one occupant gets in the conveyance, the output of the warming and cooling device is increased (150%) compared to when four occupants get in the conveyance, and the required temperature T1 required by the occupant is approached in a shorter period of time.

In addition, by identifying the position of the occupant, the blowing port of the air conditioner, the direction of the louver, or the like is automatically optimized, so that a comfortable space is efficiently created. The capacity can be maximized in a narrow space rather than a wide space.

In addition, efficiency is improved by operating only the air conditioner, the heater, or the like in a portion where the occupant is seated, and enabling an operation only in the required portion. For example, a hot or cold portion of the human body is detected using thermography or a temperature sensor built into the seat, and comfortable warm or cold air is locally sent to the portion.

In such a manner, since only the required portion can be efficiently heated, discomfort can be quickly removed with low electric power consumption. As a result, the output of the vehicle air conditioner that consumes a large amount of electric power can be suppressed, thereby leading to electric power saving for the vehicle.

In addition, when the position where the occupant H is seated or the number of occupants can be identified, as shown in FIG. 10, the temperature may be increased to the base temperature T2, which is a base, by the vehicle air conditioner, and the deviation temperature a that is a shortfall of the required temperature T1 required by the occupant H can be compensated for by the warm air devices 6 or the like installed in the vicinity of the occupant H.

Even when a plurality of users having different temperature preferences are seated in the vehicle cabin, the temperature can be fine-adjusted by temperature adjustment devices in the vicinities of the human bodies. In addition, since the vehicle air conditioner 70 may be set to obtain the base temperature T2 (lower than the required temperature T1 set by the user) that is a base, the vehicle air conditioner 70 may not be operated at high output. Namely, a decrease in the temperature of the heater core in the vehicle air conditioner 70 or a decrease in the output of the blower can be expected, thereby being able to lead to electric power saving for the vehicle.

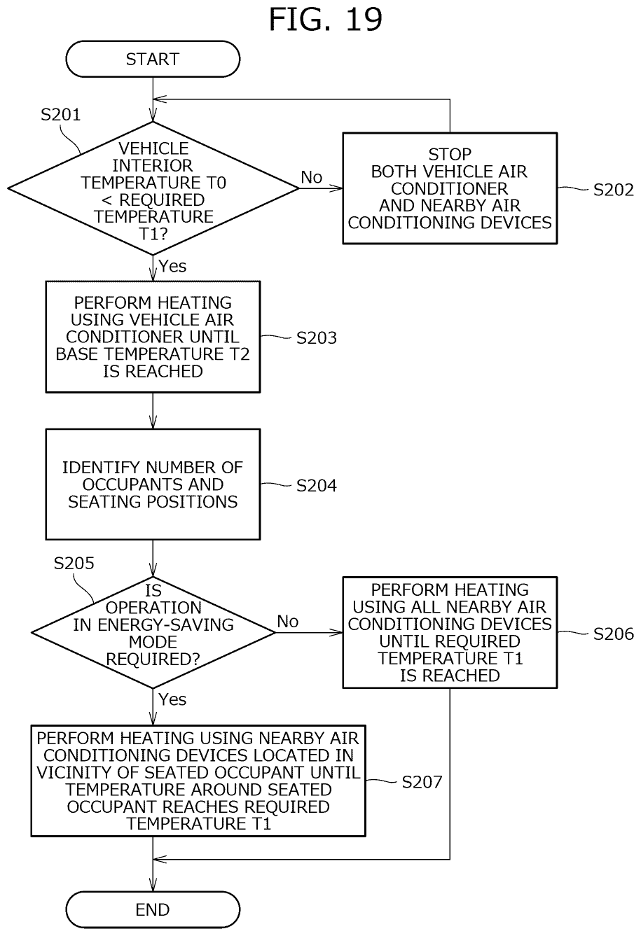

An air conditioning process using occupant detection information will be described with reference to FIG. 19. When the required temperature T1 is input by the occupant H, the vehicle interior temperature T0 and the required temperature Tl are compared to each other (step S201). When the vehicle interior temperature T0 is higher than the required temperature T1 (step S201: No), the vehicle air conditioner 70 and the nearby air conditioning devices including the warm air devices 6 and the like are stopped, and the states of the vehicle interior temperature TO and the required temperature T1 are continuously monitored (step S202).

When the vehicle interior temperature T0 is lower than the required temperature T1 (step S201: Yes), the interior is heated by the vehicle air conditioner 70 until the base temperature T2 is reached (step S203).

Next, the number of occupants and seating positions are identified using the seat belt reminders, the in-vehicle camera, or the like (step S204).

Next, the ECU determines whether an operation in an energy-saving mode is required, based on information such as the number of occupants and the remaining battery charge (step S205). When it is determined that the operation in an energy-saving mode is not required (step S205: No), the interior is heated using all the nearby air conditioning devices including the warm air devices 6 until the required temperature T1 is reached (step S206). At this time, the air conditioning devices may be operated in a state where the output is increased than the normal state. A comfortable temperature can be reached more quickly by proactively using electric power.

When the ECU determines that the operation in an energy-saving mode is required (step S205: Yes), heating is performed using only the nearby air conditioning devices which can perform heating most efficiently, such as the warm air devices 6 of the seat in which the occupant is seated (step S207). In such a manner, by identifying the number of occupants and the seating positions, and using the warm air devices 6 and the like installed in the vehicle V, more efficient air conditioning can be performed.

The conveyance assembly or the air conditioning method that is an embodiment of the present invention has been described above with reference to the drawings. Incidentally, the present invention is not limited to the conveyance assemblies installed in ground-traveling conveyances including wheels such as automobiles and trains, and can also be applied to, for example, conveyance assemblies installed in aircrafts, ships, or the like that move in environments other than the ground.

### REFERENCE SIGNS LIST

V, VA, VB, VB1, VB2: vehicle (conveyance)
M: conveyance assembly
S, SA, SB: conveyance seat (interior member)
   FS: front seat
   RS: rear seat
D: conveyance door
   DL: door lining (interior member)
   Da: upper portion
   Db: center portion
   Dc: lower portion
FL: floor
   FLm: floor member (interior member)
R: roof
F: seat frame
T: skin material
P: pad material
H: occupant
B: battery
1: seat back
2: seat cushion
3: headrest
   3a: headrest frame
   3b: headrest stay
4: rail device
   4a: lower rail
   4b: upper rail
   4c: actuator
   4d: harness
5: reclining device
   5a: reclining device cover
   5b: actuator
   5c: engagement portion
10: seat back frame
11: back side frame
12: upper frame
13: lower frame
14: connecting frame
15: wire member
16: pressure-receiving member
17: pillar support portion
20: seat cushion frame
21: cushion side frame
22: pan frame
23: front connecting frame
24: rear connecting frame
25: support member
26: bolster portion
27: ventilation hole
28: harness through hole
29: cover attachment seat (attachment portion)
   29a: cover attachment hole
6, 6A, 6B, 6C: warm air device (air conditioning device)
60: housing
61: sirocco fan (blowing device)
62: heater (heating device)
63: blowing port
64: louver
65: motor
66: bolt
67: fastener
70: vehicle air conditioner
71: air conditioning unit
72: duct
81, 81A: back-side blower fan
82: cushion-side blower fan
83: upper portion-side duct
84: lower portion-side duct
85: electromagnetic valve

1. A conveyance assembly, comprising:
an interior member provided in a conveyance,
wherein the interior member is composed of at least a conveyance seat,
the interior member includes an air conditioning device, and
the air conditioning device includes a housing, a blowing device accommodated in the housing, and a heating device accommodated in the housing and disposed in a blowing direction of air blown by the blowing device.

2. The conveyance assembly according to claim 1,
wherein a blowing port for discharging the air is formed in the housing of the air conditioning device, and
the heating device is provided adjacent to the blowing port.

3. The conveyance assembly according to claim 1,
wherein the conveyance seat includes a seat frame serving as a skeleton of the conveyance seat, and
the air conditioning device is attached to the seat frame.

4. The conveyance assembly according to claim 3,
wherein the seat frame includes a side frame located at a side portion of the conveyance seat, and
the air conditioning device is attached to a side surface of the side frame.

5. The conveyance assembly according to claim 4,
wherein the conveyance seat includes a bolster portion at the side portion of the conveyance seat, and
a ventilation hole facing a blowing port of the air conditioning device attached to the side frame is formed in the bolster portion.

6. The conveyance assembly according to claim 5,
wherein the conveyance seat includes a seat cushion that supports buttocks of a seated occupant,
the seat frame includes a cushion side frame located at a side portion of the seat cushion, and
the air conditioning device is attached to the cushion side frame, and blows the air toward a chest region of the occupant.

7. The conveyance assembly according to claim 1,
wherein the conveyance seat is provided with an attachment portion for attaching another member separate from the air conditioning device, and
the air conditioning device is disposed at a position avoiding the attachment portion for the other member.

8. The conveyance assembly according to claim 4,
wherein another member separate from the air conditioning device is attached to the side frame, and
the air conditioning device is disposed at a position avoiding the other member attached to the side frame.

9. The conveyance assembly according to claim 1,
wherein the interior member includes a door lining for a conveyance door, and
the air conditioning device is attached to the door lining.

10. The conveyance assembly according to claim 1,
wherein the interior member includes a floor member forming a floor of the conveyance, and
the air conditioning device is attached to the floor member.

11. A method of manufacturing a conveyance assembly, comprising:
preparing an interior member provided in a conveyance and composed of at least a conveyance seat,
preparing an air conditioning device that includes a housing, a blowing device and a heating device,
accommodating the blowing device in the housing,
accommodating the heating device in the housing,
disposing the heating device in the blowing direction of air blown by the blowing device, and
providing the air conditioning device in the interior member.

12. The method of manufacturing the conveyance assembly according to claim 11,
wherein a blowing port for discharging the air is formed in the housing of the air conditioning device, and
the heating device is provided adjacent to the blowing port.

13. The method of manufacturing the conveyance assembly according to claim 11,
wherein the conveyance seat includes a seat frame serving as a skeleton of the conveyance seat, and
the air conditioning device is attached to the seat frame.

14. The method of manufacturing the conveyance assembly according to claim 13,
wherein the seat frame includes a side frame located at a side portion of the conveyance seat, and
the air conditioning device is attached to a side surface of the side frame.

15. The method of manufacturing the conveyance assembly according to claim 14,
wherein the conveyance seat includes a bolster portion at the side portion of the conveyance seat, and
a ventilation hole facing a blowing port of the air conditioning device attached to the side frame is formed in the bolster portion.

16. The method of manufacturing the conveyance assembly according to claim 15,
wherein the conveyance seat includes a seat cushion that supports buttocks of a seated occupant,
the seat frame includes a cushion side frame located at a side portion of the seat cushion, and
the air conditioning device is attached to the cushion side frame, and blows the air toward a chest region of the occupant.

17. The method of manufacturing the conveyance assembly according to claim 11,
preparing an attachment portion for attaching another member separate from the air conditioning device,
attaching the attachment portion to the conveyance sheet,
disposing the air conditioning device at a position avoiding the attachment portion for the other member.

18. The method of manufacturing the conveyance assembly according to claim 14,
wherein another member separate from the air conditioning device is attached to the side frame, and
the air conditioning device is disposed at a position avoiding the other member attached to the side frame.

19. The method of manufacturing the conveyance assembly according to claim 11,
preparing a door lining for a conveyance door, that composes the interior member, and
attaching the air conditioning device to the door lining.

20. The method of manufacturing the conveyance assembly according to claim 11,
preparing a floor member that composes the interior member and forms a floor of the conveyance, and
attaching the air conditioning device to the floor member.
